(19) United States
(12) Patent Application Publication
(10) Pub. No.: US 2005/0117069 A1
(43) Pub. Date: Jun. 2, 2005

(54) Signal receiver for reveiveg simultaneously a plurality of broadcast signals

(76) Inventor: David Lowell McNeely, Indianapolis, IN (US)

Correspondence Address: Joseph S Tripoli;Thomson Licensing Inc, P O Box 5312, Princeton, NJ, 08543-5312, US

(21) Appl. No.: 10/508,270

(22) PCT Filed: Mar. 19, 2003
(86) PCT No.: PCT/US03/08365

(30) Foreign Application Priority Data
Mar. 21, 2002 (US) 60366506

(51) Int. Cl. H04N 5/44

(52) U.S. Cl. 348/725

(57) ABSTRACT

A multi-channel signal receiver enables, among other things, a plurality of frequency channels to be simultaneously tuned so that broadcast channel programs included within the frequency channels may be simultaneously accessed. According to an exemplary embodiment, the multi-channel signal receiver includes a signal source operative to generate digital information representing a plurality of broadcast channel programs. Signal processing circuitry including a filter bank is coupled to the signal source, and is operative to simultaneously provide base band signals corresponding to the plurality of broadcast channel programs.

The present invention generally relates to signal receiving devices, and more particularly, to a multi-channel signal receiver which enables, among other things, a plurality of frequency channels to be simultaneously tuned so that broadcast channel programs included within the frequency channels may be simultaneously accessed.

Conventional devices such as direct broadcast satellite (DBS) receivers can tune to a single physical frequency channel corresponding to a single satellite transponder out of an ensemble of transponders. This physical frequency channel carries a single bit stream including digital packets corresponding to data such as audio and/or video data of multiple virtual channels. Such virtual channels from the same transponder may for example be time division multiplexed from the bit stream at the receiver and simultaneously digitally processed for features such as picture-in-picture (PIP), and recording one virtual channel while viewing another.

With such conventional receiving devices, the process for tuning one physical frequency channel out of a plurality of frequency channels may for example include mixing a radio frequency (RF) signal containing multiple frequency channels with the center frequency of the frequency channel of interest and using a filtering process to pass the frequency channel of interest and reject all other frequency channels. Accordingly, with this conventional tuning process only a single physical frequency channel can be tuned at once, and multiple receiving devices may be required if more than one frequency channel is to be tuned at the same time.

The requirement of multiple receiving devices can be unduly expensive and inconvenient for many households that, for example, desire to simultaneously watch different television programs (on different televisions) where the different television programs are included in different frequency channels. In such cases, the household must invest in additional receiving devices equal to the number of frequency channels its desires to tune at the same time. For example, if a given household desires to tune up to four different frequency channels at once (e.g., so that four different users can independently watch four different television programs included in four different frequency channels), then four separate receiving devices are required.

Accordingly, there is a need for a signal receiving apparatus which avoids the foregoing problems, and can simultaneously tune to all available frequency channels in a given network. In this manner, multiple users can simultaneously access broadcast channel programs included within the multiple frequency channels. The present invention addresses these and other issues.

In accordance with an aspect of the present invention, a multi-channel signal receiver is disclosed. According to an exemplary embodiment, the multi-channel signal receiver comprises a signal source for generating digital information representing a plurality of broadcast channel programs. Signal processing means including a filter bank, is operatively coupled to the signal source for simultaneously providing base band signals corresponding to the plurality of broadcast channel programs.

In accordance with another aspect of the present invention, a method for controlling a multi-channel signal receiver is disclosed. According to an exemplary embodiment, the method comprises generating digital information representing a plurality of broadcast channel programs, and simultaneously generating base band signals corresponding to the plurality of broadcast channel programs.

The above-mentioned and other features and advantages of this invention, and the manner of attaining them, will become more apparent and the invention will be better understood by reference to the following description of embodiments of the invention taken in conjunction with the accompanying drawings, wherein:

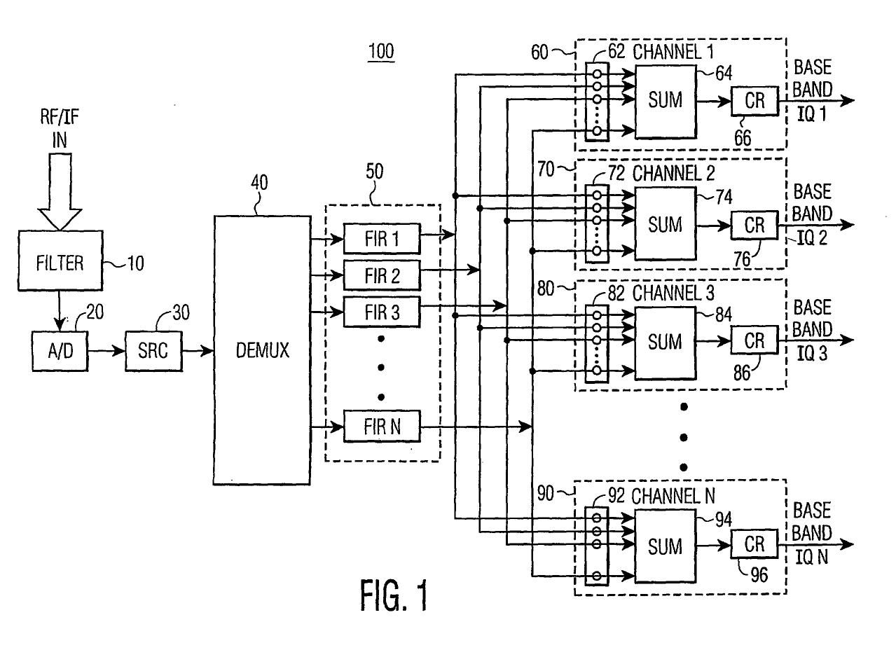

FIG. 1 is a diagram of a multi-channel signal receiver according to the present invention;

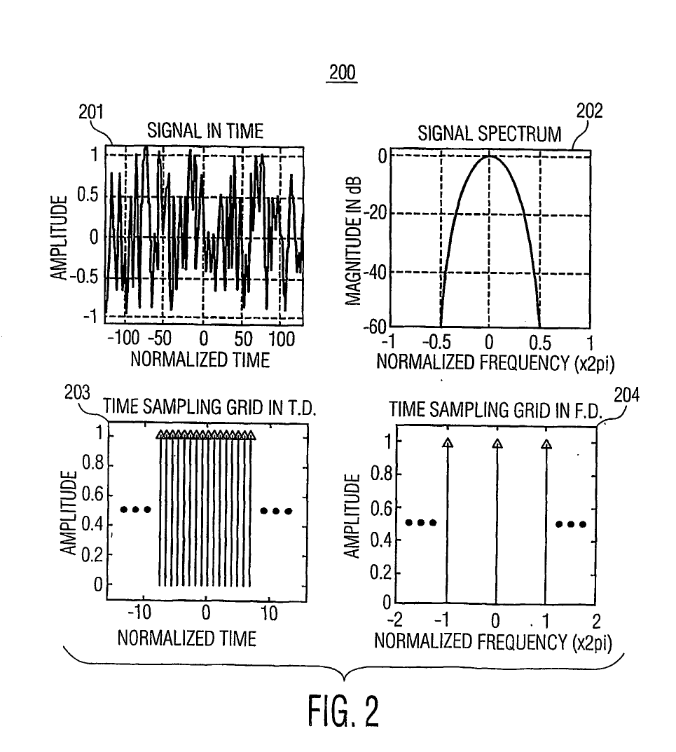

FIG. 2 is a diagram illustrating an exemplary time signal and sampling grid in the time and frequency domains;

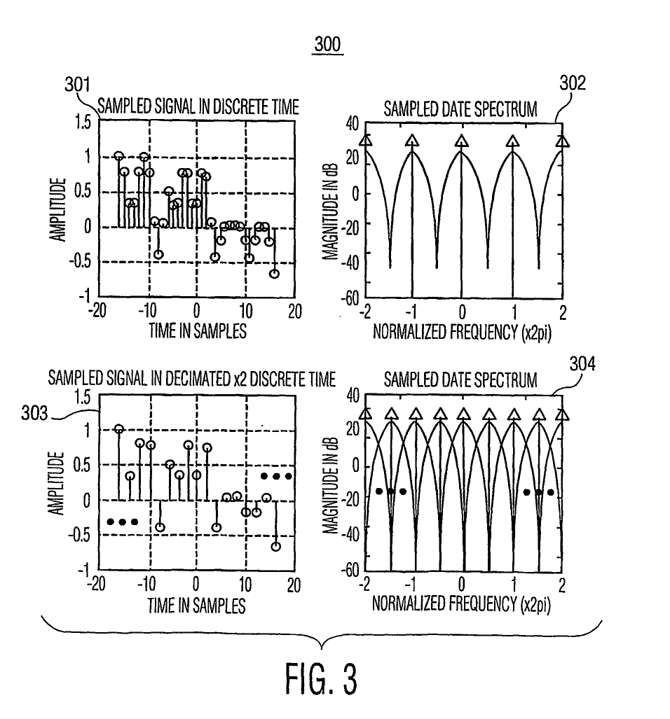

FIG. 3 is a diagram illustrating un-aliased and aliased samplings;

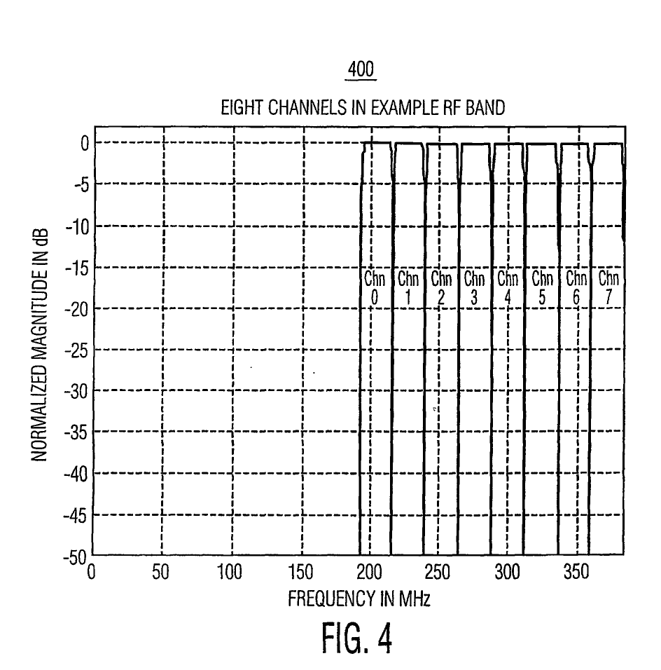

FIG. 4 is a diagram illustrating channels in an exemplary RF frequency band;

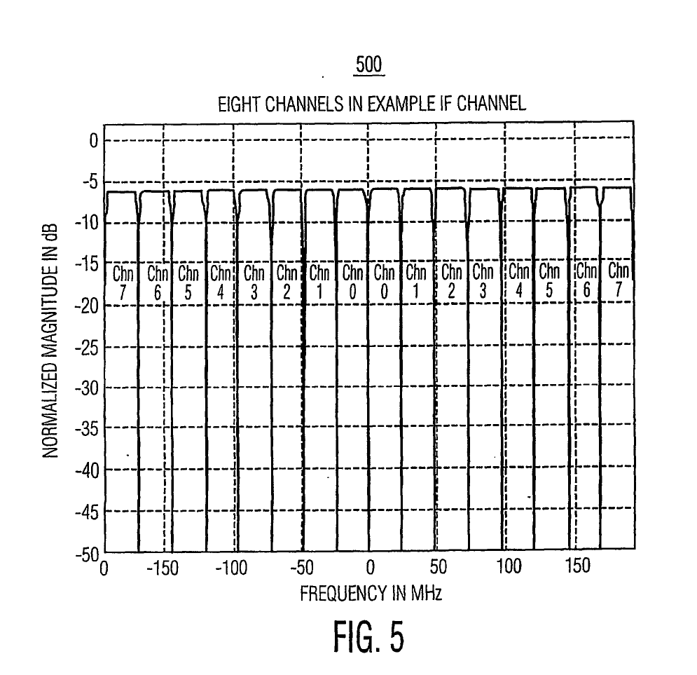

FIG. 5 is a diagram illustrating an exemplary multi-channel IF signal derived from an RF signal;

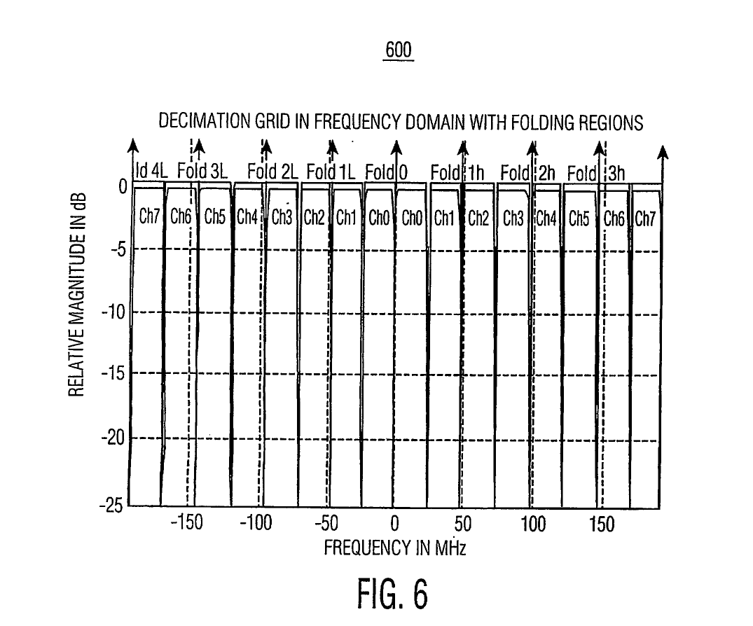

FIG. 6 is a diagram illustrating aliasing of all frequency channels into a first Nyguist region;

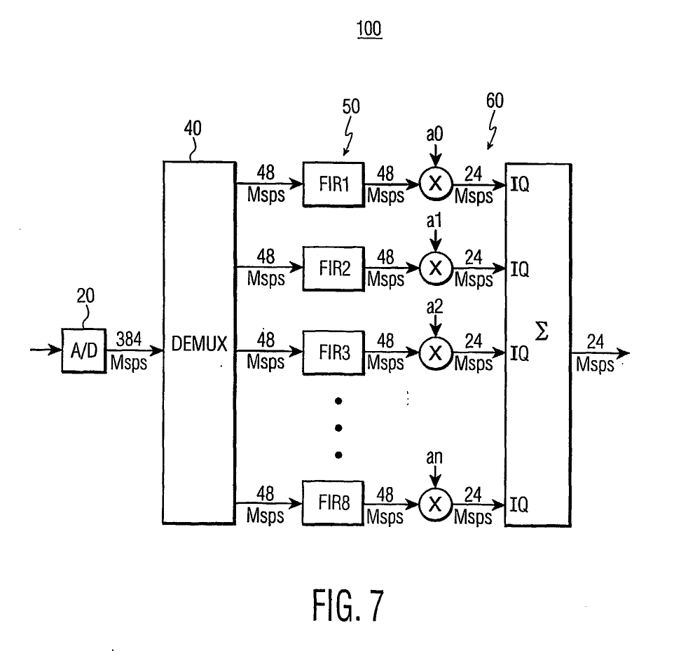

FIG. 7 is a diagram of a relevant portion of the multi-channel signal receiver of FIG. 1 as applied to an example;

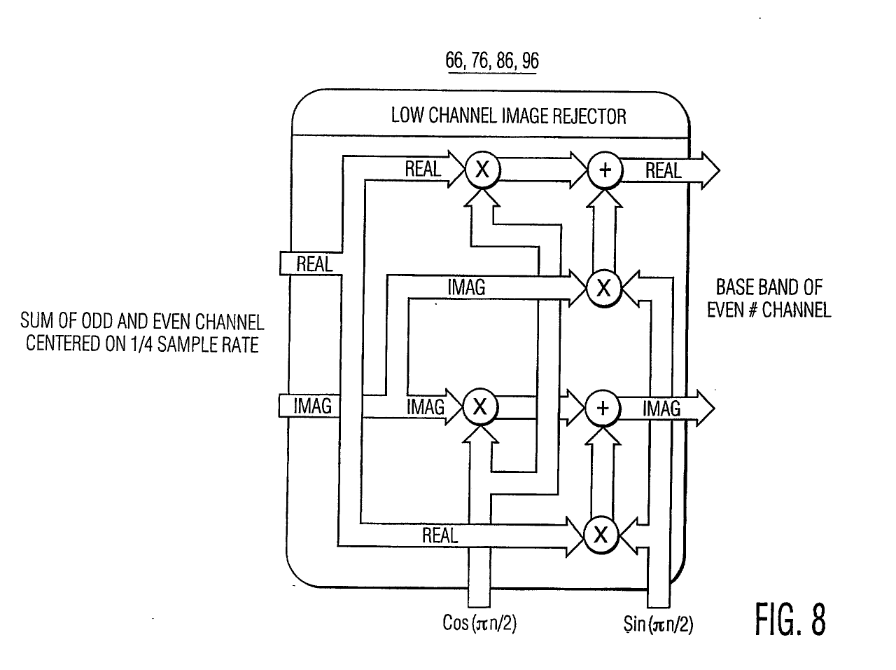

FIG. 8 is a diagram of an image rejector;

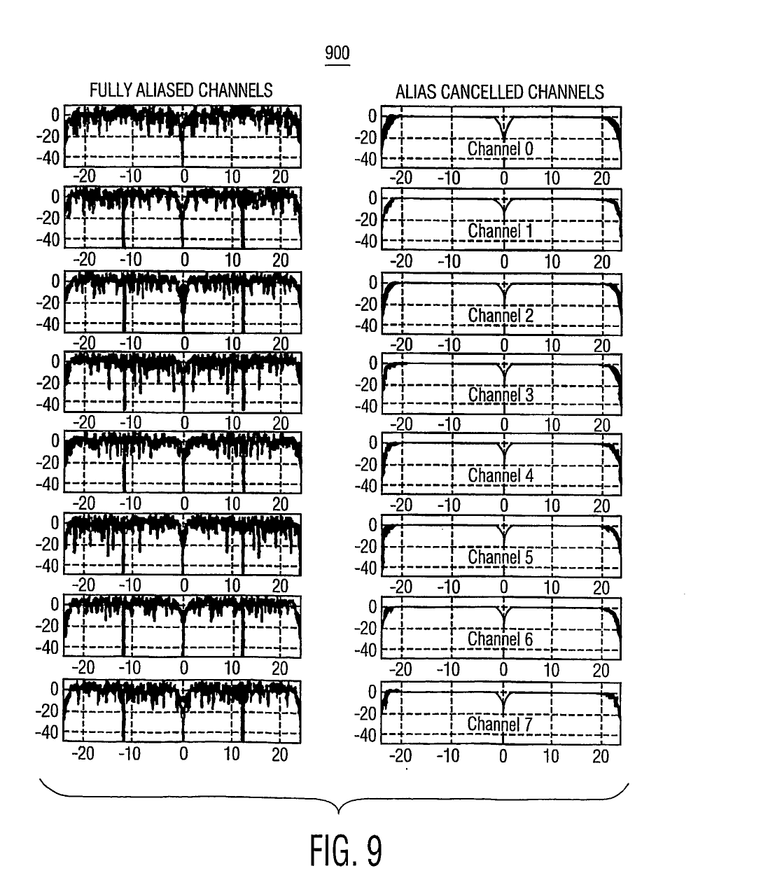

FIG. 9 is a diagram illustrating the recovery of desired frequency channels by the phased sum of decimations;

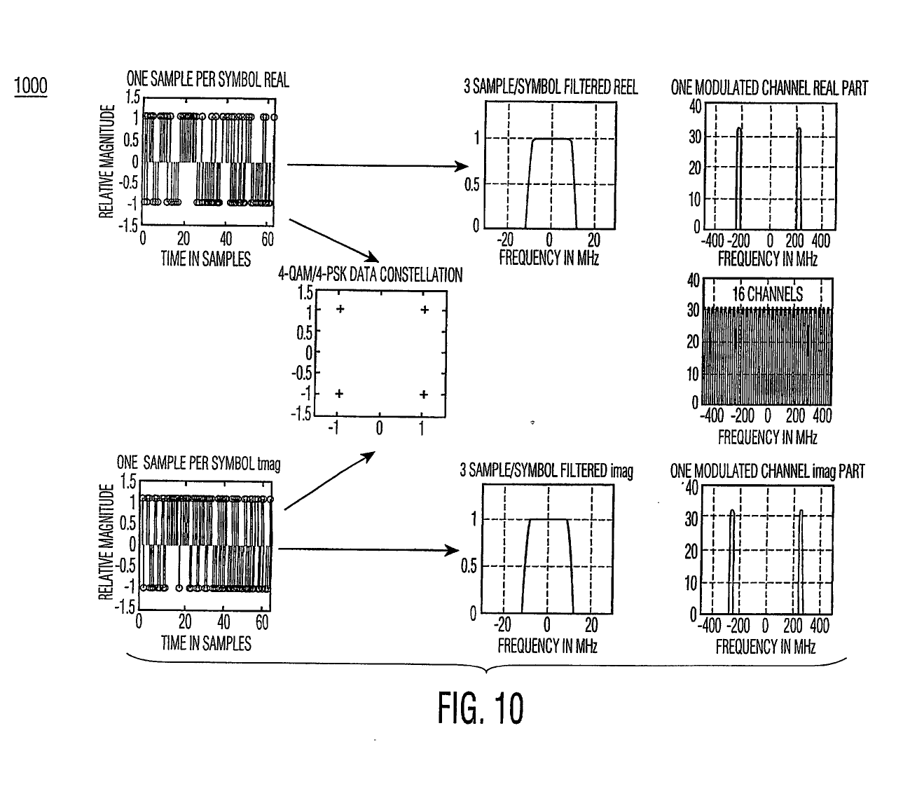

FIG. 10 is a diagram illustrating exemplary data at the transmitter;

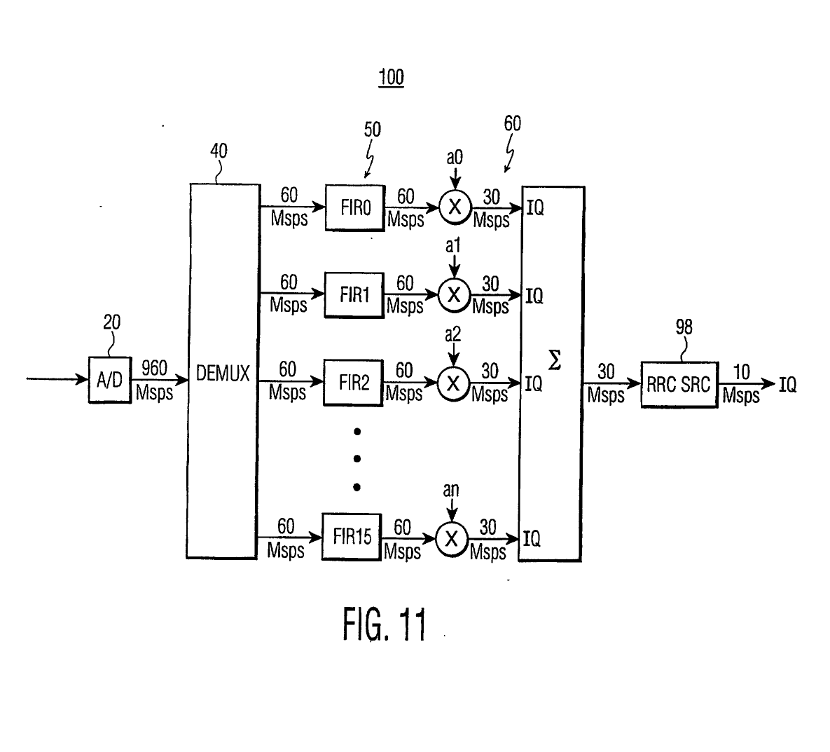

FIG. 11 is a diagram of a relevant portion of the multi-channel signal receiver of FIG. 1 as applied to another example;

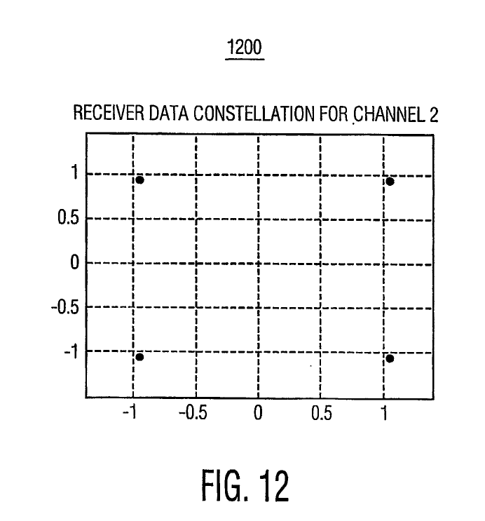

FIG. 12 is a diagram illustrating an exemplary receiver data constellation.

The exemplifications set out herein illustrate preferred embodiments of the invention, and such exemplifications are not to be construed as limiting the scope of the invention in any manner.

Referring now to the drawings, and more particularly to FIG. 1, a diagram of a multi-channel signal receiver 100 according to the present invention is shown. As will be described herein, multi-channel signal receiver 100 enables a plurality of frequency channels to be simultaneously tuned such that broadcast channel programs included within the frequency channels may be simultaneously accessed.

As shown in FIG. 1, receiver 100 comprises a signal source including a filter block 10, an analog-to-digital (A/D) converter 20, an optional sample rate converter (SRC) 30, and a demultiplexer 40. Receiver 100 further comprises signal processing means which function as a signal cancellation tuner and comprise a filter bank 50, and signal processing channels 60 to 90. Signal processing channels 60 to 90 include multiplication blocks 62 to 92, sum blocks 64 to 94, and channel rejection (CR) blocks 66 to 96, respectively. The foregoing elements of FIG. 1 may be embodied on one or more integrated circuits (ICs).

According to an exemplary mode of operation, an input signal to receiver 100 is a radio frequency (RF) or intermediate frequency (IF) analog signal carrying N adjacent channels {ch1 to chN} whose respective center frequencies are {F₁ . . . F_{N}} with a channel spacing of F_{S}=(F_{I}−F_{I-1}). The input signal may for example be provided to receiver 100 via any wired or wireless network, including but not limited to any satellite, cable, terrestrial or other network (such as broadcast and/or commercial networks). Each channel contains a modulation on its carrier (center frequency) of bandwidth F_{bw} with an excess bandwidth of x% and a guard band F_{gb}=(F_{S}−F_{bw}*(100+x)/100). According to an exemplary embodiment, the input signal may also possess special properties. For example, the frequency variance of the channel spacing may be essentially zero and/or the symbol timing and carrier offset may be common channel to channel. The present invention does not require these special properties, but they may be exploited to advantage in its framework.

Filter block 10 receives the RF/IF input signal and performs a filtering operation thereon. According to principles of the present invention, there are at least four different embodiments of this filtering operation. According to one embodiment, filter block 10 spectrally moves the band of N channels such that the lowest frequency channel (e.g., Channel 1) carrier F₁=F_{S}/2, and anti-alias filtering of the band of N channels is performed to allow use of the minimum Nyquist sampling rate. Accordingly, with this embodiment A/D converter 20 may be clocked at the minimum Nyquist sampling rate F_{Samp}=2*N*F_{S} {T=1/(2*N*F_{S})}.

According to another embodiment, filter block 10 performs a filtering operation to a relaxed specification with a broad transition band of width P*Fₛ above and below the N channel band to reach acceptable stop band attenuation, where P is an integer. Moreover, the lowest frequency channel is spectrally moved so that its carrier F₁=F_{S}/2+P*F_{S}. With this embodiment, A/D converter 20 is clocked at the sampling rate F_{Samp}=2*(N+2*P)*F_{S}, and the number of parallel paths used for signal cancellation tuning is N+2*P. The energy just outside of the N channel band which was not removed by filtering will be removed by cancellation with the same process that cancels the energy of competing channels. This embodiment may allow filter block 10 to utilize smaller, lower performance filters, rather than physically larger and lossy SAW filters.

According to still another embodiment, filter block 10 filters the band of N channels as in Case 1 or Case 2 represented below in this paragraph, and the frequency of the highest channel's uppermost frequency is arranged to fall on an even folding frequency of a sub-Nyquist sampling rate, F_{F}. This technique is used to fold the band of N channels into the position for valid F_{N}'s satisfying {F_{F}=2*(F_{N}+F_{S}/2)/k=2*N*F_{S} {Case 1}} or {F_{F}=(F_{N}+(P+0.5)*Fs)/k=2*(N+2*P)*F_{S} {Case 2}}.

According to yet another embodiment, filter block 10 filters the band of N channels as in Case 3 or Case 4 represented below in this paragraph, and the frequency of the lowest channel's lowest frequency is arranged to fall on an even folding frequency of a sub-Nyquist sampling rate, F_{F}. This technique is used to fold the band of N channels (with spectral inversion) into the position for valid F₁'s satisfying {F_{F}=2*(F₁−F_{S}/2)/k=2*N*F_{S} (Case 3}} or {F_{F}=(F₁−(P+0.5)*Fs)/k=2*(N+2*P)*F_{S} {Case 4}}.

After the filtering operation of filter block 10, the resultant RF/IF signal is digitally converted by A/D converter 20 so that it is represented by a discrete time sequence of samples indexed by n {n*T=the time the RF/IF signal's amplitude was measured}. According to an exemplary embodiment, the sample time spacing T is chosen as a sub-multiple of 1/(2*M*F_{S}), where M≧N. It is important to note that the sample sequence may be the direct output of A/D converter 20, or an output of optional SRC 30 representing a calculated sequence derived from some sampling (uniform or non-uniform) not conforming to desired sample spacing T. While the operations of filter block 10 described above establish conditions for the direct application of signal cancellation tuning according to the present invention, the constraints of filter block 10's operations on the clock rate of A/D converter 20 can be relaxed somewhat by inclusion of optional SRC 30 in which case such constraints apply to the outputs of SRC 30.

Demultiplexer 40 is operative to demultiplex the resulting sample stream output from A/D converter 20 (or optional SRC 30) into a plurality of decimated sample streams each transporting a sample data signal which is heavily aliased with images of all frequency channels, and is at a convenient rate for digital signal processing. Filter bank 50 is operative to receive the output sample streams from demultiplexer 40 and perform a filtering operation thereon. According to an exemplary embodiment, filter bank 50 includes a plurality of finite impulse response (FIR) filters that apply differential delays to the sample streams provided from demultiplexer 40 in such a manner that the output of each filter estimates the same time samples from the different offset sampling grids at the corresponding filter inputs. For example, the frequency dependent delay of a first filter of filter bank 50 (i.e., FIR 1) may be referenced as zero differential delay to its received sample stream, while a second filter (i.e., FIR 2) applies a delay relative to this reference delay of T to its received sample stream, a third filter (i.e., FIR 3) applies a differential delay of 2T to its received sample stream, and an Nth filter (i.e., FIR N) applies an (N−1)T differential delay to its received sample stream. In this manner, the sample streams output from filter bank 50 estimate a plurality of same time samples, each exhibiting a differently phased sum of aliased channels.

Signal processing channels 60 to 90 are operative to process the sample streams output from filter bank 50 using the principles of signal cancellation tuning to thereby enable a plurality of frequency channels to be simultaneously tuned such that broadcast channel programs included within the frequency channels may be simultaneously accessed. Once present, an aliased component cannot be separated from an un-aliased component occupying the same frequency band by a filtering process. However, as each decimated sample stream output from filter bank 50 has its own unique phasing of each original frequency channel's alias, any frequency channel's signal can be calculated uncontaminated from other frequency channel aliases from the ensemble of sample streams.

According to the principles of the present invention, each frequency channel in the ensemble has associated with it a unique weighting vector, a. In order to tune to frequency channel n out of 8, a weighting vector of exp(j2πn*(0 . . . 7)/8) {IQ complex base band} or cos(2πn*(0 . . . 7)/8) {real band pass} is applied to the decimated sample stream output from filter bank 50 by one of multiplication blocks 62 to 92 of signal processing channels 60 to 90. One should note that each value of n will cause a different channel to be received, but the channel tuned with n is not in strict frequency order and is dependent on down stream options. An example correspondence may be n={0,1,2,3,4,5,6,7} yields ch={0,2,4,6,7,5,3,1}. The outputs of the given multiplication block (i.e., one of 62 to 92) are summed by the corresponding sum block (i.e., one of 64 to 94) and then output to a channel rejection block (i.e., one of 66 to 96). As will be described later herein, the outputs of each sum block 64 to 94 may contain two channels (an odd and even channel pair). These two channels end up co-occupying one frequency channel, and are separable by phase relationships present at the output of sum block 64 to 94. Rejection of the undesired odd numbered channel of the pair may be performed using the channel rejector of FIG. 8. Similarly, rejection of the even numbered channel of the superimposed pair can be obtained by changing the adders in FIG. 8 into subtractors. In this manner, base band signals corresponding to multiple frequency channels can be simultaneously tuned using the signal processing channels 60 to 90 of FIG. 1. As previously indicated herein, broadcast channel programs (e.g., television, radio, data, etc.) may be represented as virtual channels within a given frequency channel, and may for example be time division multiplexed from the bit stream.

To provide a better understanding of the inventive concepts of the present invention and the exemplary embodiment of FIG. 1, some sample data concepts and examples will hereinafter be provided.

Referring to FIGS. 2 and 3, some of the sample data concepts utilized by the present invention are represented. In particular, FIG. 2 is a diagram 200 illustrating an exemplary time signal and sampling grid in the time and frequency domains, and FIG. 3 is a diagram 300 illustrating un-aliased and aliased samplings.

In FIG. 2, consider the 1-D continuous time signal, s(t), represented in graph 201 whose band limited frequency spectra, S(f), is represented in graph 202. Further consider a sampling grid, g(t), modeled as a unit area impulse (delta function) train:

$$g ( t ) = {\sum }_{n = - ∞}^{∞} δ ( t - n \cdot T ) ,$$

Where δ(●) is the dirac delta function, and T=Grid Spacing as represented in graph 203. The frequency representation of the sampling grid, g(t), is analytically determined by a Fourier transform integral:

$$\begin{matrix}G ( ω ) = {\int }_{- ∞}^{∞} g ( t ) \cdot {ɛ}^{- j \cdot ω \cdot t} \cdot ⅆ t \\ = {\int }_{- ∞}^{∞} ( {\sum }_{n = - ∞}^{∞} δ ( t - n \cdot T ) ) {ɛ}^{- j \cdot ω \cdot t} \cdot ⅆ t \\ = {\sum }_{n = - ∞}^{∞} ( {\int }_{- ∞}^{∞} δ ( t - n \cdot T ) \cdot {ɛ}^{- j \cdot ω \cdot t} \cdot ⅆ t ) \\ = {\sum }_{n = - ∞}^{∞} {ɛ}^{- j \cdot ω \cdot n \cdot T} \\ = ( {\sum }_{n = 0}^{∞} {( {ɛ}^{- j \cdot ω \cdot T} )}^{n} + {ɛ}^{- j \cdot ω \cdot n \cdot T} \cdot {\sum }_{n = 0}^{∞} {( {ɛ}^{- j \cdot ω \cdot T} )}^{n} )\end{matrix}$$

$$Noting \{ \frac{1}{1 - x} = {\sum }_{n = 0}^{∞} {x}^{n} , ∀ x \neq 1 \} ⇒ G ( ω ) = \frac{1}{1 - {ɛ}^{j \cdot ω \cdot T}} + \frac{{ɛ}^{- j \cdot ω \cdot n \cdot T}}{1 - {ɛ}^{- j \cdot ω \cdot T}}$$

$$\begin{matrix}G ( ω ) = \{ \begin{matrix}\frac{1}{1 - {ɛ}^{j \cdot ω \cdot T}} - \frac{1}{1 - {ɛ}^{j \cdot ω \cdot T}} = 0 , & ∀ ω \cdot T \neq m \cdot ( 2 π ) \\ ∞ , & ∀ ω \cdot T = m \cdot ( 2 π )\end{matrix} \} \\ = {\sum }_{n = - ∞}^{∞} δ ( ω - n \cdot ( \frac{2 π}{T} ) )\end{matrix}$$

The operation of sampling analog signal, s(t), on sampling grid, g(t), to obtain a sampled data representation of s(t), s(n), is modeled as:

$$s ( n ) = s ( t ) \cdot g ( t ) = {\sum }_{n = - ∞}^{∞} s ( n \cdot T ) \cdot δ ( t - n \cdot T )$$

If the time domain impulse spacing is one (1), then the frequency domain impulse spacing is two (2). If the time domain impulse train includes an impulse at time zero (assumed above), then the frequency domain impulse train is real value weighted. If the time domain impulse train is offset from time zero (0) by normalized time units (where normalized spacing equals one (1)), then each impulse in the frequency domain impulse train is weighted by:
e^{-j2π·n·α}, where n=the impulse's normalized frequency index.

The time continuous signal of graph 201 of FIG. 2 sampled at a rate equal to twice its band limit (i.e., Nyquist sampling rate) is illustrated in graph 301 of FIG. 3. Graph 302 of FIG. 3 illustrates the frequency ambiguity of this sampling. In particular, the image about zero (0) frequency is an un-aliased copy of the continuous signal. The time continuous signal of graph 201 is sampled at a rate equal to its band limit (i.e. ½ Nyquist sampling rate) in graph 303 of FIG. 3, while graph 304 illustrates the alias spectra (red) which contaminates the un-aliased spectra (blue) of graph 302. All sampling phases yield this result, but the phase of each complex valued image is a function of the sampling phase.

The signal cancellation tuner of the present invention is a novel application of the sampling theory represented in FIGS. 2 and 3. According to the present invention, channel selectivity is obtained using a signal cancellation process rather than the common filtering process. The signal cancellation process of the present invention will now be illustrated by two examples.

According to the first example, eight (8) frequency channels are available for tuning and each frequency channel has a 20 MHz bandwidth. Additionally, the channel spacing is 24 MHz, and the excess bandwidth is 20%. This example may for instance represent a variation of a current DBS application. Referring to FIG. 4, a diagram 400 illustrating these eight (8) frequency channels in an exemplary RF frequency band is provided. As shown in FIG. 4, the RF frequency band from 192 to 384 MHz contains eight 20 MHz channels (i.e., Chn0 to Chn7). Below is exemplary simulation code that may be used to generate FIG. 4.

MATLAB Script for FIG. 4

x=2*srseq(8,8)−(256−sqrt(256))/255;% 8 different M sequences (rows)
for l=1:8,% Each sequence is upsampled, RRC filtered & put on a different carrier
rrc=[ones(1,512),cos(pi/2*(0:127)/128),cos(pi/2*(128:−1:1)/128),ones(1,512)];
rrc=rrc(1:5:length(rrc));zx=[16,fftshift(fft(x(l,:)))].*fftshift(rrc);
zz(l,:)=real(ifft(fftshift([zeros(1,15*256+128),zx,zeros(1,15*256+128)]))).*cos(((l−
1)*pi/16+17*pi/32)*(0:8191));
end;
hold off,
for i=1:8,f=20*log10((abs(fft(zz(i,:)/8))));plot(((0:4095)/256)*24,f(1:4096)),hold on,end
xlabel(’Frequency in MHz’); ylabel(’Normalized Magnitude in dB’);
title(’Eight Channels in Example RF Band’); axis([0 8*48,−50 2])

According to this example, an RF signal including the eight (8) channels represented in FIG. 4 may be sampled by A/D converter 20 (see FIG. 1) at a rate of 768 MHz (or higher), or may be sampled after being demodulated to near base band (i.e., 192 MHz maps to DC) by filter block 10. To facilitate explanation, after-demodulation sampling will be detailed.

For illustration purposes, assume a near base band multi-channel bearing IF signal is sampled at a sufficient rate that all frequency channels fall within the first Nyquist region (i.e., un-aliased case). The ideal case is that all frequency channels of interest are on a carrier equal to (n+½)*channel bandwidth, as represented by diagram 500 in FIG. 5. Note that sampling this eight (8) channel band at 320 mega samples per second (Msps) will create a first Nyquist region of support hugging the eight (8) channel band. Below is exemplary simulation code that may be used to generate FIG. 5.

Matlab Script for FIG. 5

x=2*srseq(8,8)−(256−sqrt(256))/255;zz=[ ];% 8 different M sequences
(rows)
for l=1:8,% Each sequence is upsampled, RRC filtered & put on a
different carrier
rrc=[ones(1,512),cos(pi/2*(0:127)/128),cos(pi/2*(128:−1:1)/128),
ones(1,512)];
rrc=rrc(1:5:length(rrc));zx=[16,fftshift(fft(x(l,:)))].*fftshift(rrc);
zz(l,:)=real(ifft(fftshift([zeros(1,7*256+128),zx,zeros(1,7*256+128)]))).
*cos(((l−1)*pi/8+pi/16)*(0:4095));
end;
hold off,
for i=1:8;plot(((0:4095)/256−8)*24,20*log10(fftshift(abs(fft(zz(i,:)/16))))),
hold on,end
xlabel(’Frequency in MHz’); ylabel(’Normalized Magnitude in dB’)
title(’Eight Channels in Example IF Channel’); axis([−8*24 8*24,−50 2])

Now suppose that the 384 Msps stream is sorted into eight (8) decimated by eight 48 Msps streams by demultiplexer 40 (see FIG. 1) in which case each of the decimated streams is heavily aliased with the specta of all 20 MHz bandwidth channels folded into the same 20 MHz frequency channel. Each decimated stream is 1:1 sample rate converted to the same 40 Msps sampling grid (note that each stream is offset sampled with respect to one another since they are different decimations of the same sample stream). Referring to FIG. 6, a diagram 600 illustrating each of the eight (8) frequency channels folded into the same 20 MHz frequency channel is shown. Below is exemplary simulation code that may be used to generate FIG. 6.

MATLAB Script for FIG. 6

x=2*srseq(8,8)−(256−sqrt(256))/255;zz=[ ];% 8 different M sequences
(rows)
for l=1:8,% Each sequence is upsampled, RRC filtered & put on a
different carrier
rrc=[ones(1,512),cos(pi/2*(0:127)/128),cos(pi/2*(128:−1:1)/128),
ones(1,512)];
rrc=rrc(1:5:length(rrc));zx=[16,fftshift(fft(x(l,:)))].*fftshift(rrc);
zz(l,:)=real(ifft(fftshift([zeros(1,7*256+128),zx,zeros(1,7*256+128)]))).
*cos(((l−1)*pi/8+pi/16)*(0:4095));
end;zzz=sum (zz);
hold off,X=([reshape([−.95 .95 1]’*ones(1,9)+ones(3,1)*[−8:2:8],
1,27) ]*24);
Y=reshape([.5 .5 −50]’*ones(1,9),1,3,*9);line(X,Y);
hold on;%for l=24*(−8:2:8),line([l,l],[−50 2]),end
plot(((0:4095)/256−8)*24,20*log10(fftshift(abs(fft(zzz/8))))),hold off

Referring to FIG. 7, a diagram of a relevant portion of the multi-channel signal receiver 100 of FIG. 1 as applied to the first example is shown. To facilitate explanation, only one signal processing channel 60 is shown in FIG. 7.

As previously indicated herein, each frequency channel in the ensemble has associated with it a unique weighting vector, a. In order to tune to channel n out of 8, a weighting vector of exp(j2πn*(0 . . . 7)/8) {IQ complex base band} or cos(2πn*(0 . . . 7)/8) {real band pass} is applied by the multipliers of processing channel 60. Also in FIG. 7, a real 48 Msps to complex 48 Msps base band conversion can be accomplished at the same time {i.e., weighting vector a is exp(j2πn*(0 . . . 7)/8)*exp(±jπm/2), n=q(chn), q converts a channel # to the value of n characterizing the vector resulting in reception of channel chn, m=sample index, + to tune to even channels, − to tune to odd channels). After half band filtering a decimation by 2 realizes a 24 Msps complex base band signal.

If demodulation is not combined with the vector weighting as in FIG. 7, one cannot immediately down sample by two (2), and the 48 Msps complex samples must be summed and down sampled post-demodulation. It is important to note that each Nyquist region (except the first) contains two channels (an odd and even channel pair). These two channels end up co-occupying one frequency channel. These two channels are separable by phase relationships present at the output in FIG. 7. Rejection of the undesired odd numbered channel of the pair may be performed using the channel rejector of FIG. 8. Similarly, rejection of the even numbered channel of the superimposed pair can be obtained by changing the adders in FIG. 8 into subtractors. The difference in hardware between FIG. 8 and conventional demodulators is that the input is complex rather than real.

Referring to FIG. 9, a diagram 900 illustrating the recovery of desired frequency channels by the phased sum of decimations is shown. In particular, FIG. 9 shows a comparison between fully aliased frequency channels and the alias cancelled frequency channels in the first example. Note in FIG. 9 that the x-axes represent normalized frequency, while the y-axes represent relative magnitude. Below is exemplary simulation code that may be used to generate FIG. 9.

Matlab Script for FIG. 9

```
for i=1:8,subplot(8,2,i*2−1);
plot(((0:511)/256−1)*24,fftshift(20*log10(abs(fft(zzz(i,:)/2)))));
  axis([−24 24 −50 10]);
  grid
end
for i=1:8,
  z4(i,:)=real(ifft(fft(zzz(i,:)).*(fft((Mu(9−i,:)*F)/64,512))));
end
for i=1:8,
  subplot(8,2,i*2);
  zx=exp(j*2*pi*(0:7)/8*(i−1))*z4;
  plot(((0:511)/256−1)*24,fftshift(20*log10(abs(fft(zx/8)))));
  axis([−24 24 −50 10]);
  grid
end
```

The first example described above used a “real” modulation (amplitude modulation) to generate clear figures. Next, a second example will be provided to further illustrate the principles of the present invention. In particular, this second example is based on a two-bit phase shift keyed (4-PSK) complex modulated signal and focuses on data constellations. According to this second example, eight (8) frequency channels are available for tuning and each frequency channel has a 20 MHz bandwidth. Additionally, the channel spacing is 30 MHz, and the excess bandwidth is 20%. Like the first example, this second example may also represent a variation of a current DBS application.

To illustrate the transmission and reception of symbol streams with the second example, a time sequence of 2^{N}−1 two-bit quadrature amplitude modulated (4-QAM) symbols {45 degree rotation of 4-PSK) will be formed as a stream of complex numbers wherein the real and imaginary streams are DC shifted pseudo random number (PRN) {−1,1} periodically extended M-sequences. As both time and frequency domains are cyclic continuous, the fast Fourier transform (FFT) exactly relates the time and frequency domains. At 20 Msps the base band signals at the transmitter are as in shown in diagram 1000 of FIG. 10 and are root raised cosine (RRC) filtered. Below is exemplary simulation code that may be used to generate FIG. 10.

Matlab Script for FIG. 10

%Transmitter Model:
%4-PSK/4-QAM symbols in 10MHz BW base band
x=2*srseq(8,16)−(256−sqrt(256))/255;
xx=x+j*x(:,[64:255,1:63]);%these are the symbols
subplot(3,4,1);stem(x(1,1:64));title(’One Sample per Symbol {Real}’);
xlabel(’Time in Samples’);ylabel(’Relative Magnitude’);axis([0 63 −
1.5 1.5])
subplot(3,4,9);stem(x(1,65:128));title(’One Sample per Symbol {Imag}’);
xlabel(’Time in Samples’);ylabel(’Relative Magnitude’);
axis([0 63 −1.5 1.5])
subplot(3,4,6);plot(xx,’*’);title(’4-QAM/4-PSK Data Constellation’);
axis([−1.5 1.5 −1.5 1.5]);
rrc=fftshift(abs(fft(sqrcos(510,.201,2)))).’/2;
fxr=fft(real(xx).’);fxi=fft(imag(xx).’);% @ one sample /symbol
fxr=[fxr;fxr].*(rrc*ones(1,16));fxi=[fxi;fxi].*(rrc*ones(1,16));%rrc filtered
[r,c]=size(fxr);
xr=ifft(fxr([(r/2+1):r,1:r],:)).’;% @ two samples/symbol
xi=ifft(fxi([(r/2+1):r,1:r],:)).’;% @ two samples/symbol
%upsample 2 to 3 so that Nyquist Folding Frequency = Channel
Spacing = 30 MHz
subplot(3,4,3);ff=[zeros(128,16);fxr;zeros(127,16)];yr=ifft(ff([384:765,
1:383],:)).’;
ff=[zeros(128,16);fxi;zeros(127,16)];yi=ifft(ff([384:765,1:383],:)).’;
plot((0:764)/765*60−30,fftshift(abs(fft(yr.’)/16)));axis([−30 30 0 1.4]),grid
title(’3 Sample/Symbol Filtered Real’);xlabel(’Frequency in MHz’);
subplot(3,4,11);plot((0:764)/765*60−30,fftshift(abs(fft(yi.’)/16)));
axis([−30 30 0 1.4]),grid
title(’3 Sample/Symbol Filtered Imag’);xlabel(’Frequency in MHz’);
% UpSample by 16 so that First Nyquist Region = 16*30
MHz = 480 MHz
% Modulate each channel by its carrier, 15+30*chn MHz
{pi/32+pi/16*chn}
chn={0..15}
ff=fft([yr,yr,yr,yr].’);k=2*765;
fff=[zeros(765*30,16);ff([k+(1:k),1:k],:);zeros(765*30,16)];k=32*765;
xr16=ifft(fff([k+(1:k),1:k],:)).’.*cos((pi/16*(0:15)’+pi/32)*
(0:(64*765−1)));
ff=fft([yi,yi,yi,yi].’);k=2*765;
fff=[zeros(765*30,16);ff([k+(1:k),1:k],:);zeros(765*30,16)];k=32*765;
xi16=ifft(fff([k+(1:k),1:k],:)).’.*sin((pi/16*(0:15)’+pi/32)*
(0:(64*765−1)));
x16=sum(xr16+xi16);% this is the received signal
%A to D Quantization Model is inserted here
subplot(3,4,4),z=fftshift(abs(fft(xr16(8,:))));
z=z([2:4:(length(×16)/2),length(×16)/2+(4:4:(length(×16)/2))]);
plot((0:(length(z)−1))/length(z)*960−480,z);
title(’One Modulated Channel {real part}’);
xlabel(’Frequency in MHz’),grid,axis([−480 480 0 40])
subplot(3,4,12),z=abs(fft(xi16(8,:)));
z=z([4:4:(length(×16)/2),length(×16)/2+(2:4:(length(×16)/2))]);
plot((0:(length(z)−1))/length(z)*960−480,z);
title(’One Modulated Channel {imag part}’);
xlabel(’Frequency in MHz’),grid,axis([−480 480 0 40])
subplot(3,4,8);z=abs(fft(sum(xr16)));z=max(reshape(z,4,length(z)/4));
plot((0:(length(z)−1))/length(z)*960−480,z)
title(’16 Channels’);xlabel(’Frequency in MHz’),grid,axis([−480
480 0 40])

Referring to FIG. 11, a diagram of a relevant portion of the multi-channel signal receiver 100 of FIG. 1 as applied to the second example is shown. The genera operation of receiver 100 in FIG. 11 is the same as in FIGS. 1 and 7, although in FIG. 11 the outputs from signal processing channel 60 are processed by an RRC SRC 98. FIG. 12 is a diagram 1200 illustrating an exemplary receiver data constellation according to the second example. In particular, FIG. 12 shows an exemplary receiver data constellation for channel 2. In FIG. 12, the slight constellation offset is due to a slight DC offset of the I and Q {1, −1} M sequences for flat spectra at the transmitter. Below is exemplary simulation code that may be used to generate FIG. 12.

MATLAB Script for FIG. 12

| %sort 960 Msps A/D stream into 16 streams | |
|---|---|
| y16=reshape(×16,16,length(×16)/16); | |
| %put 16 streams upon the same 60 Msps grid | |
| %note rows of F are FIR's in inverse order | |
| F= | [−2 2 −3 5 −6 8 −11 21 251 −11 4 −1 0 0 −1 0 |
| | −2 3 −4 7 −8 12 −19 38 246 −24 10 −5 3 −1 0 0 |
| | −3 4 −5 8 −11 17 −26 58 238 −34 16 −9 6 −3 1 −1 |
| | −3 4 −6 10 −14 21 −34 80 228 −42 21 −12 6 −4 2 −1 |
| | −3 5 −7 10 −16 24 −39 100 215 −47 24 −14 9 −6 3 −2 |
| | −3 5 −7 12 −17 27 −47 122 199 −52 27 −16 10 −6 4 −2 |
| | −3 5 −8 12 −18 29 −49 142 181 −52 29 −18 11 −7 5 −3 |
| | −3 5 −7 12 −18 29 −52 162 162 −52 29 −18 12 −7 5 −3 |
| | −3 5 −7 11 −18 29 −52 181 142 −49 29 −18 12 −8 5 −3 |
| | −2 4 −6 10 −16 27 −52 199 122 −47 27 −17 12 −7 5 −3 |
| | −2 3 −6 9 −14 24 −47 215 100 −39 24 −16 10 −7 5 −3 |
| | −1 2 −4 6 −12 21 −42 228 80 −34 21 −14 10 −6 4 −3 |
| | −1 1 −3 6 −9 16 −34 238 58 −26 17 −11 8 −5 4 −3 |
| | 0 0 −1 3 −5 10 −24 246 38 −19 12 −8 7 −4 3 −2 |
| | 0 −1 0 0 −1 4 −11 251 21 −11 8 −6 5 −3 2 −2 |
| | 1 −1 2 −2 2 −3 2 254 2 −3 2 −2 2 −1 1 0]/256; |

ys16=ifft(fft(y16.’).*fft(flipud(F).’,4*765));
%convert from real to base band IQ
yb16r=ys16.’.*(ones(16,1)*cos(pi/2*(0:3059)));
yb16i=ys16.’.*(ones(16,1)*sin(pi/2*(0:3059)));
yb=yb16r+j*yb16i;
%select channel
chn=2;
a=exp(j*2*pi*chn/16*(0:15));
desired_chn=a*yb;
%root raised cosine filter
rrc=abs(fft(sqrcos(510,.2,3),3060));
desired_chn=ifft(fft(desired_chn).*rrc);
plot(desired_chn(2:3:3060)*2,’.’),axis([−1.4 1.4 −1.4 1.4])
title([’Receiver Data Constellation for Channel ’,int2str(chn)])

As described herein, the present invention advantageously provides a multi-channel signal receiver that enables all physical frequency channels to be accessed simultaneously with a low incremental cost for each additional channel. In this manner, broadcast channel programs included within the frequency channels may be simultaneously accessed. The concepts of the present invention may provide a natural way to apply digital signal processing to RF signal processing with the maximum amount of circuitry running at the lowest possible clock rate. Moreover, other applications of the present invention may exist by employing real to complex IQ signal representation at different stages of the process and applying sample rate conversion at different stages of the process.

While this invention as been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A multi-channel signal receiver, comprising:
a signal source for generating digital information representing a plurality of broadcast channel programs; and
signal processing means including a filter bank, operatively coupled to the signal source for simultaneously providing base band signals corresponding to the plurality of broadcast channel programs.

2. The multi-channel signal receiver of claim 1, wherein the signal source comprises:
filtering means for generating filtered analog signals;
analog-to-digital conversion means for converting the filtered analog signals to digital signals; and
means for demultiplexing the digital signals to output the digital information representing the plurality of broadcast channel programs.

3. The multi-channel signal receiver of claim 2, wherein the signal source further comprises sample rate conversion means for performing a sample rate conversion operation on the digital signals output from the analog-to-digital conversion means.

4. The multi-channel signal receiver of claim 1, wherein the signal processing means comprises a plurality of signal processing channels, and each processing channel generates one of the base band signals within a unique frequency channel.

5. A method for controlling a multi-channel signal receiver, comprising:
generating digital information representing a plurality of broadcast channel programs; and
simultaneously generating base band signals corresponding to the plurality of broadcast channel programs.

6. The method of claim 5, further comprised of:
generating filtered analog signals;
converting the filtered analog signals to digital signals; and
demultiplexing the digital signals to output the digital information representing the plurality of broadcast channel programs.

7. The method of claim 6, further comprised of performing a sample rate conversion operation on the digital signals prior to demultiplexing.

8. The method of claim 5, wherein each one of the generated base band signals is included within a unique frequency channel.

9. A multi-channel signal receiver, comprising:
a signal source operative to generate digital information representing a plurality of broadcast channel programs; and
signal processing circuitry including a filter bank, coupled to the signal source and operative to simultaneously provide base band signals corresponding to the plurality of broadcast channel programs.

10. The multi-channel signal receiver of claim 9, wherein the signal source comprises:
a filter operative to generate filtered analog signals;
an analog-to-digital converter operative to convert the filtered analog signals to digital signals; and
a demultiplexer operative to demultiplex the digital signals and thereby output the digital information representing the plurality of broadcast channel programs.

11. The multi-channel signal receiver of claim 10, wherein the signal source further comprises a sample rate converter operative to perform a sample rate conversion operation on the digital signals output from the analog-to-digital converter.

12. The multi-channel signal receiver of claim 9, wherein the signal processing circuitry comprises a plurality of signal processing channels, and each processing channel is operative to generate one of the base band signals within a unique frequency channel.
